(19) United States
(12) Patent Application Publication
(10) Pub. No.: US 2020/0391158 A1
(43) Pub. Date: Dec. 17, 2020

(54) REVERSE OSMOSIS CENTRIFUGE

(71) Applicant: Eden Technologies, LLC, Cheyenne, WY (US)

(72) Inventors: Hunter Ferdinand Manz, Las Vegas, NV (US); Zachary Wayne Manweiler, St. George, UT (US)

(73) Assignee: Eden Technologies, LLC, Cheyenne, WY (US)

(21) Appl. No.: 16/899,198

(22) Filed: Jun. 11, 2020

Related U.S. Application Data
(60) Provisional application No. 62/859,786, filed on Jun. 11, 2019.

(51) Int. Cl. B01D 61/06; B01D 61/08; B01D 71/02; B01D 71/16; C02F 1/44

(52) U.S. Cl. CPC B01D 61/06; B01D 61/08; C02F 2103/08; B01D 71/16; C02F 1/441; B01D 71/021

(57) ABSTRACT

The reverse osmosis centrifuge converts rotational energy into fluid velocity and conserves the energy placed into the concentrate. As concentrate travels back towards the center of the reverse osmosis centrifuge, the velocity of the fluid is converted into rotational force, thus conserving energy placed into the concentrate. To accomplish this, the reverse osmosis centrifuge includes a support shaft, a plurality of receiving tubes, a plurality of housings with filters therein, a plurality of departure tubes, and a permeate trough. The plurality of receiving tubes are coupled to a top of the plurality of housings, while the plurality of departure tubes are coupled to a bottom of the plurality of housings. Centrifugal force creates the permeate and concentrate. The permeate exits the plurality of housings and is deposited into the permeate trough. The concentrate travels through, and exists from, the plurality of departure tubes.

### CROSS-REFERENCE TO RELATED APPLICATIONS

This application claims the benefit of U.S. Provisional Application Ser. No. 62/859,786, filed on Jun. 11, 2019, which is incorporated herein by reference.

### TECHNICAL FIELD

The present disclosure relates to desalination. More particularly, the present disclosure relates to a centrifugal system and method to aid in desalination of water.

### BACKGROUND

Because human life depends upon fresh water, there is a constant need to find new sources or to uncover ways of producing fresh water. Due to the amount of saltwater on the planet, there is an obvious need to convert the salt water to fresh water. As a result, several desalination methods exist in the art, including ultrasonic methods, electrolysis, and other specialized pumping. However, these methods of desalination are very expensive, which prohibits them from being widely utilized. As a result, water shortages and droughts continue to exist for societies, even when those societies are next to oceans—our largest bodies of water. For example, California constantly faces water shortages and droughts despite being on the coast.

Much of the cost of desalination results from the energy consumption required to produce it. Most current methods of desalination rely on pressure. Currently, massive pumps are used to produce the pressure needed for desalination. As a result, these pumps consume a massive amount of energy, making them cost-prohibitive for many uses. Further, a majority of the energy placed into the system is lost in the saline concentrate produced as part of the filtration process. Accordingly, if a system and method could reduce the energy required to desalinate, the cost would decrease, thereby allowing wider use of desalinating technology and societies being less susceptible to droughts during dry seasons.

Therefore, there remains a need for a system and method that can desalinate water at significantly reduced cost and that can prevent loss of energy in the system. The present reverse osmosis centrifuge disclosed herein solves these and other problems.

### SUMMARY OF EXAMPLE EMBODIMENTS

In one embodiment, a reverse osmosis centrifuge comprises a support shaft, a plurality of receiving tubes, a plurality of housings with filters therein, a plurality of departure tubes, and a permeate trough. The plurality of receiving tubes are coupled to a top of the plurality of housings, while the plurality of departure tubes are coupled to a bottom of the plurality of housings. As seawater enters the receiving tubes, it flows to the plurality of housings, where centrifugal force creates the permeate (i.e., fresh water) and concentrate (i.e., salt water) in the plurality of housings. The permeate exits the plurality of housings and is deposited into the trough. The concentrate travels through, and exits from, the plurality of departure tubes.

In one embodiment, a reverse osmosis centrifuge comprises a rotatable housing having a water inlet and a plurality of water outlet arms, the rotatable housing being motor controlled. Each water outlet arm extends radially from the rotatable housing, the distal end of each arm comprising a saltwater outlet and a freshwater outlet. The reverse osmosis centrifuge further comprises a trough for receiving the output from the saltwater outlet and freshwater outlet, the trough divided so as to ensure separation of the fresh water from the saltwater. In one embodiment, the housing is an oblate spheroid. As a result, the water therein easily flows to the plurality of water outlets and through each arm. Pressure builds at the end of each arm due to rotational forces and the length of the arms. Accordingly, the rotationally-induced pressure (which may be referred to as “centrifugal” force) provides for desalination at a lower energy cost.

### BRIEF DESCRIPTION OF THE DRAWINGS

FIG. 1 illustrates a top perspective view of a reverse osmosis centrifuge;

FIG. 2 illustrates a top plan view of a reverse osmosis centrifuge;

FIG. 3 illustrates a bottom plan view of a reverse osmosis centrifuge;

FIG. 4 illustrates a side elevation view of a reverse osmosis centrifuge;

FIG. 5 illustrates a detailed, top perspective view of first trough and a fluid inlet of a reverse osmosis centrifuge;

FIG. 6 illustrates a perspective view of a receiving tube, a housing, and a departure tube of a reverse osmosis centrifuge;

FIG. 7 illustrates a cross-sectional view of a filter and a housing of a reverse osmosis centrifuge;

FIG. 8 illustrates a detailed, bottom perspective view of a housing and a permeate trough of a reverse osmosis centrifuge;

FIG. 9 illustrates a detailed, bottom perspective view of a second trough of a reverse osmosis centrifuge;

FIG. 10 illustrates a pressure gradient of a reverse osmosis centrifuge; and

FIG. 11 illustrates a top perspective view of a reverse osmosis centrifuge.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there remains a need for a system and method that can desalinate water at significantly reduced cost and that can prevent loss of energy in the system. As will be appreciated from this disclosure, the reverse osmosis centrifuge solves these problems and others.

Typical reverse osmosis systems for desalination comprise a reverse osmosis train (“RO Train”), which may include an intake, a high-pressure pump, a filter separated from the pump, and an energy recovery device. Filters used in reverse osmosis are unique because they require “Cross Flow Filtration.” To initiate the filtering process, the pump on typical RO Trains pushes salt water through the filter. With Cross Flow Filtration, a majority of the water mass moves across the filter, which is the saline concentrate. A desired feature of Cross Flow Filtration is that the large amount of concentrate acts as a cleanser as it moves across the filter, removing particles and prolonging the life of the filter. The water that does penetrate the filter is known as permeate and is often a small volume by percentage (e.g., 9%). The only valuable work produced by the reverse osmosis process is the permeate. However, energy is consumed by both the permeate and the concentrate. Because the concentrate is the waste product, the energy consumed by the concentrate is lost. To salvage some of the lost energy, energy recovery devices have been implemented in RO Trains. Energy recovery devices allow some of the energy that is placed into the system to be recovered. In particular, the energy recovery device was implemented in an attempt to transfer energy from the concentrate to the feed flow so as to not lose the majority of the energy consumed by the concentrate.

In contrast, the reverse osmosis centrifuge, described herein, generally conserves the energy of the concentrate by converting it to rotational energy. In one embodiment, the reverse osmosis centrifuge comprises a plurality of receiving tubes, a plurality of departure tubes, a support shaft, a plurality of housings with filters therein, and a trough. The plurality of receiving tubes are coupled to a top of the plurality of housings, while the plurality of departure tubes are coupled to a bottom of the plurality of housings. As seawater enters the receiving tubes, it flows to the plurality of housings, where centrifugal force creates the permeate and concentrate via the filters.

Centrifugal force (also known as a fictitious force) is an inertial force. This inertial force creates radial outward movement and pressure. Generally speaking, the faster an object is spinning, the greater the radially-outward force. This outward force creates pressure on seawater. The reverse osmosis centrifuge creates radial force on water entering the plurality of housings. The faster the plurality of housings spin, the greater the pressure. Unlike a RO Train, used in the prior art, where the pump is separated from the filter elements, the reverse osmosis centrifuge creates efficiencies by combining the pumping action and the filtration action into one revolving/centrifuge apparatus. Through the design of the reverse osmosis centrifuge, many major components of a RO Train become irrelevant. The two major components being replaced are the high-pressure pump and energy recovery device. Both of these devices are inherent features of the reverse osmosis centrifuge. It will be appreciated that the reverse osmosis centrifuge operates on the principle of taking water to a high pressure state, exhausting a fixed percentage of that water through the filters, and then recovering the energy in the concentrate water by taking it to a low pressure state before ejection through the plurality of departure tubes, thereby foregoing the need for an energy recovery device. Thus, and in stark contrast to the prior art, the reverse osmosis centrifuge is a cross flow filtration device that only exhausts energy into the filtered water (i.e., permeate) and not the concentrate.

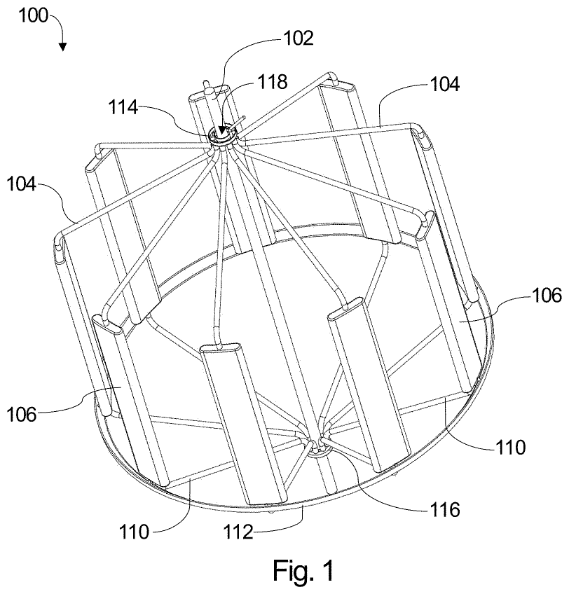

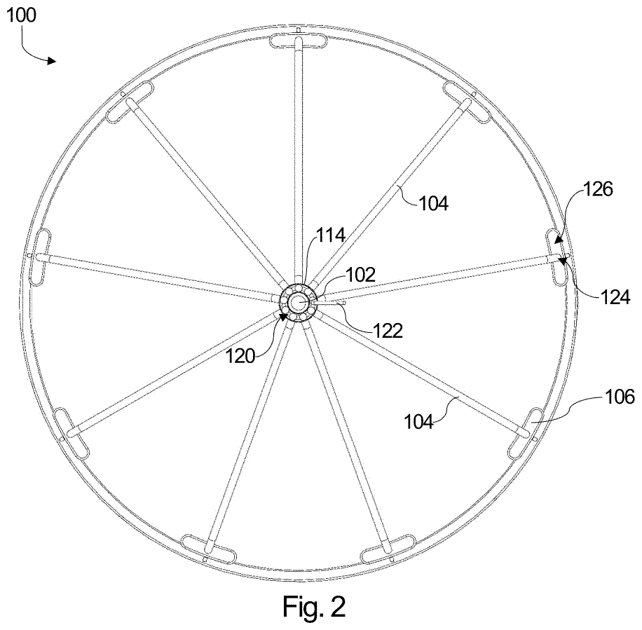

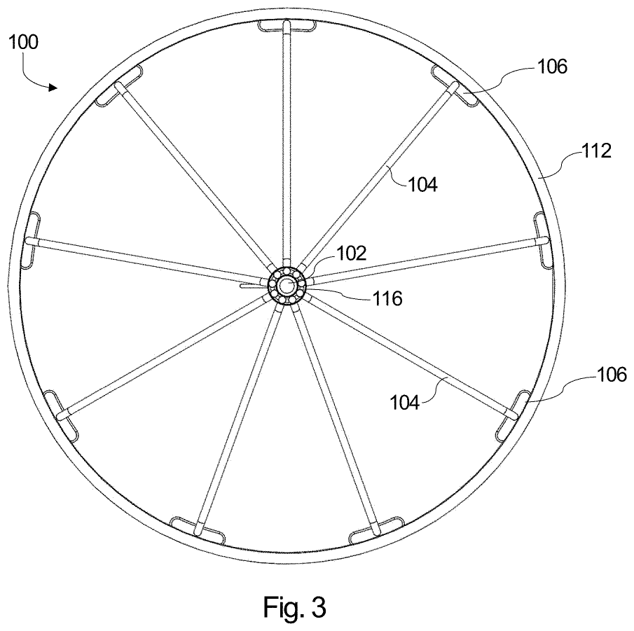

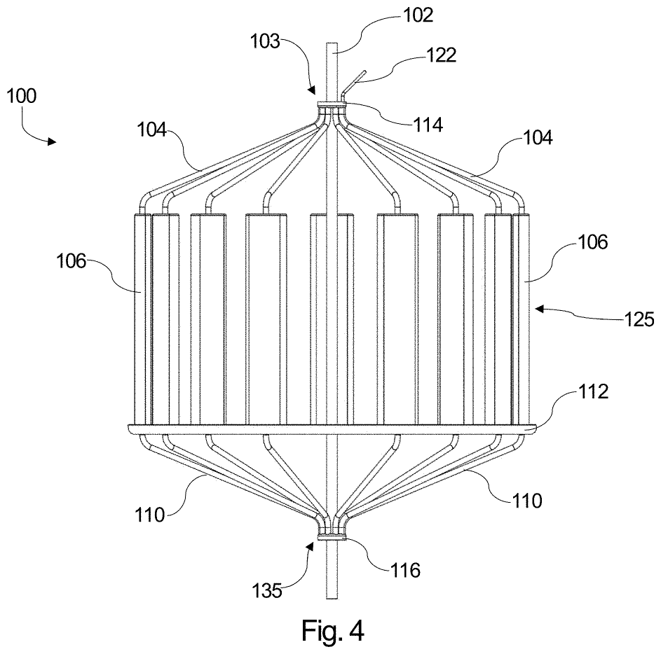

As shown in FIGS. 1-5, in one embodiment, a reverse osmosis centrifuge 100 comprises a support shaft 102, a plurality of receiving tubes 104, a plurality of housings 106 with filters 108 (e.g., reverse osmosis membranes) therein, a plurality of departure tubes 110 for the outlet of concentrate, and a permeate trough 112. The reverse osmosis centrifuge 100 may be six feet in diameter and eight feet tall. However, the reverse osmosis centrifuge 100 is not limited to those dimensions and may be other dimensions, depending upon the available energy input and desired output amount. The support shaft 102 may receive a first trough 114 and a second trough 116. The support shaft 102 may rotate (e.g., motor-controlled), thereby rotating the first and second troughs 114, 116 coupled thereto. In an alternate embodiment, the support shaft 102 may be static while the first and second troughs 114, 116 have bearings and be motor-controlled so as to rotate around the support shaft 102. The first trough 114 comprises a first support shaft aperture 118 so as to receive the support shaft 102 at a first end 103 (FIG. 4). The first trough 114 further comprises a plurality of first apertures 120. While a plurality of apertures 120 are shown, it will be appreciated that one or more apertures may be used on the first trough 114. Further, the plurality of receiving tubes 104 are coupled to the plurality of apertures 120 via a securement mechanism, such as glue, crimping, twist and lock, threads, screws, etc.

When the reverse osmosis centrifuge 100 begins to operate, saltwater enters the first trough 114 by way of a fluid inlet 122. While saltwater may enter the reverse osmosis centrifuge 100, it will be appreciated that the reverse osmosis centrifuge 100 may be used with salt-free water as well. A single fluid inlet 122 is shown; however, there may be a plurality of fluid inlets so as to deposit additional saltwater into the system. The shape and form of the fluid inlet 122 may also vary. For example, the fluid inlet 122 may be non-angled and have a large diameter. Further, in one embodiment, the first trough 114 may be sealed with, for example, a cap so that water entering through a sealed fluid inlet 122 can pressurize the system, preventing backflow of the seawater and providing for the removal of the viscous concentrate from the plurality of departure tubes 110. In one embodiment, water entering the fluid inlet 122 may be pressurized, such as by using a pump.

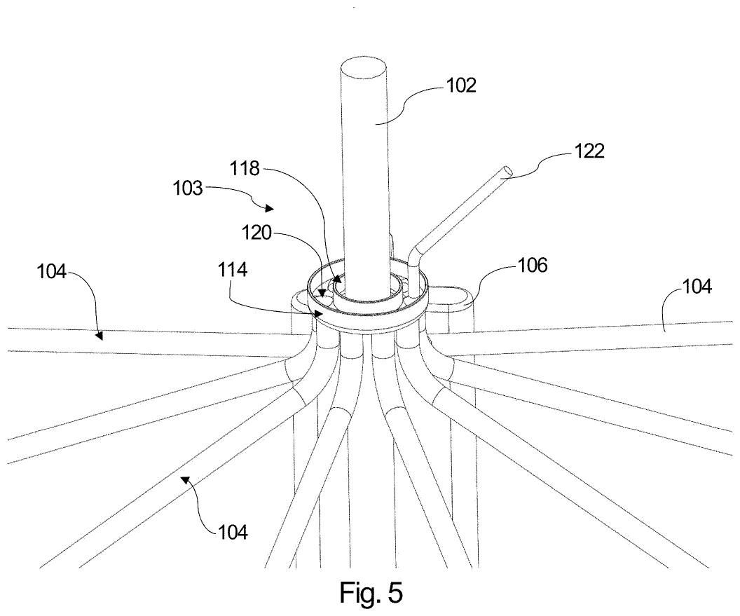

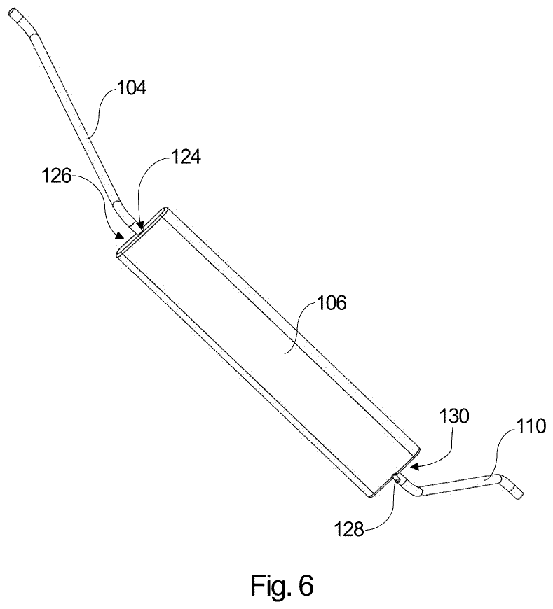

Referring to FIGS. 5-6, as saltwater enters the fluid inlet 122, it is deposited into the first trough 114 and flows into the plurality of receiving tubes 104. The plurality of receiving tubes 104 are also coupled to receiving apertures 124 on a top 126 of the plurality of housings 106. In a similar manner to the fluid inlet 122, the plurality of receiving tubes 104 may be a different shape, diameter, or both. The saltwater deposited into the plurality of receiving tubes 104 is eventually deposited into the plurality of housings 106, at a second position 125 that is radially distant to the shaft 102, via gravity and centrifugal force. The plurality of housings 106 may be vertically positioned, allowing gravity to induce the feed flow (flow of saltwater through the reverse osmosis centrifuge).

In one embodiment, the plurality of housings 106 may be stacked vertically to increase permeate production, while maintaining the same square footage. Further, in one embodiment, the stacked housings 106 may have static turbines therebetween so as to drive feed flow. The plurality of housings 106 may be made of a fiberglass material that can compensate for pressure differential cycles during rotation, which creates better aerodynamics, structural resistance to a pressure differential, and vibration resistance. However, the plurality of housings 106 are not limited to fiberglass and may be other materials, such as aluminum, carbon fiber, plastic, etc.

In addition, the plurality of housings 106 may be a single unit that is seamless, airtight, and a smooth enclosure, thereby decreasing the windage effect. With the plurality of housings 106 being airtight, a body of air is sealed inside. At RPM, the body of air undergoes the same centrifugal and pressure gradient effects as the saltwater, forcing the air against the housing 106. If the plurality of housings 106 are not airtight, then unnecessary air consumption may occur. However, in some embodiments, the plurality of housings may be multiple sealable components that may be removably attachable and adjustable.

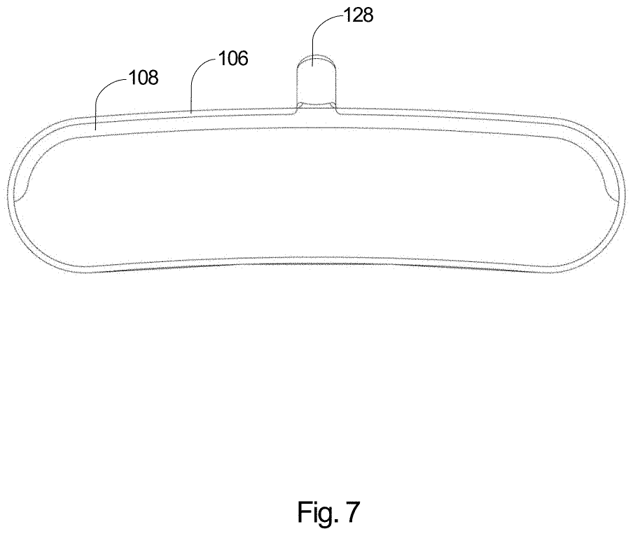

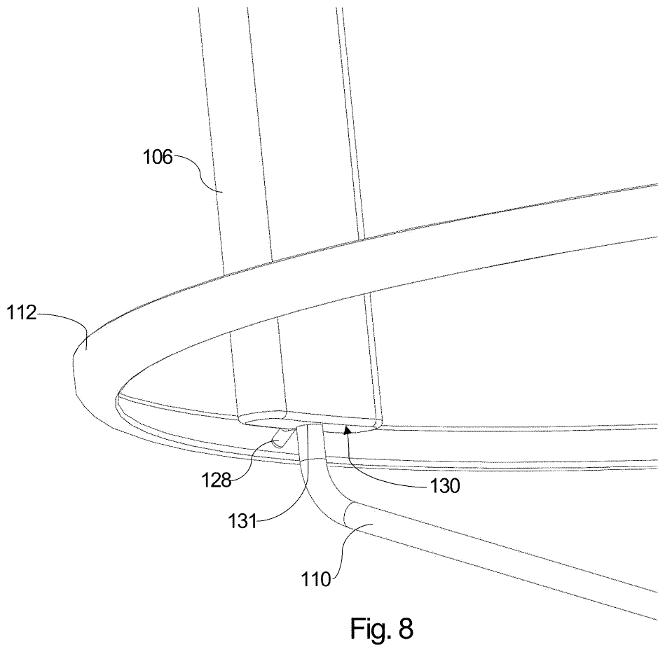

As shown in FIG. 7-8, the filter 108 may be positioned inside, and coupled to, the plurality of housings 106. The filter 108 may be coupled to the plurality of housings 106 with an attachment mechanism, such as glue. It should be noted that the filter 108 follows the contours of the housing 106. In other words, the curvature of the filter 108 and the inside of the plurality of housings 106 matches the curvature of the reverse osmosis centrifuge 100, which makes use of the pressure gradient effect. By compartmentalizing each filter 108 into an individual housing 106, centrifugal force can be easily transferred into the saltwater, rather than using a larger cylindrical filter known in the prior art. Centrifugal force creates pressure and pushes the saltwater into the filter 108. The saltwater flowing across the filter 108 becomes concentrate, while the salt water/feed flow is pressurized against the filter 108, and permeate is collected on the other side of the filter 108. The filter 108 may separate the concentrate and permeate flow paths. The filter 108 may be a graphene filter, a film composite membrane, a cellulose triacetate membrane, cellulose acetate, or any other type of filter. Further, the filter 108 may have fibers that are cylindrical, spiral, etc. It will be appreciated that the geometries of the filter 108 and the housings 106 allow the exact cross flow rate induced by gravity. In other words, the saltwater falls through the concentrate flow path in the filter 108 due to gravity. Because the first position 103 (centered at the axis) is in the highest position, and the second, radially distant position 125 (distal end of the receiving tubes 104) is in a lower vertical position, gravity aids in the overall flow of the saltwater to the filter. Additionally, because the concentrate outlet is located at a third position 135, which is lower than both the first and second position 103, 125, respectively, gravity aids in the concentrate returning to the axis (shaft 102). However, a pump may also be used in some embodiments so as to increase the flow rate. The permeate is ejected through a permeate outlet 128, which is located at a bottom 130 (FIG. 8) of the plurality of housings 106, and into a permeate trough 112 where it may exit the reverse osmosis centrifuge 100.

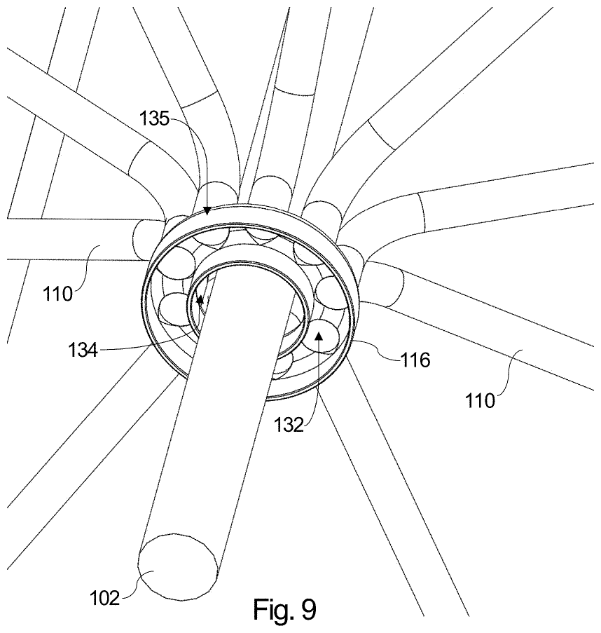

Referring to FIG. 9, while the permeate is deposited into the permeate trough 112, the concentrate is removed from the plurality of housings 106 by the plurality of departure tubes 110 that are coupled to the housings 106 by a plurality of departure apertures 131 (shown in FIG. 8). More specifically, the plurality of departure tubes 110 are coupled to the second trough 116 at a bottom of the reverse osmosis centrifuge 100, through a plurality of second apertures 132. The second trough 116 may also be coupled to the support shaft 102 via a second aperture 134, at a third position 135, which is vertically aligned with the first position 103. After the plurality of departure tubes 110 are coupled to the second trough 116, at the third position 135, the concentrate may exit therefrom. The plurality of departure tubes 110 may be a variety of shapes and sizes. In one embodiment, the diameter of the departure tubes 110 may be smaller in diameter than the diameter of the receiving tubes 104. This may be beneficial to aid in overcoming the loss of pressure due to the permeate that leaves the system. In other words, a smaller diameter departure tube 110 increases pressure to account for the pressure lost by the permeate, thereby bringing the system into equilibrium once again. Additionally, because the concentrate is denser than the incoming water in the receiving tubes 104, a higher pressure in the departure tubes 110 may be needed in some scenarios. Further, a pump may be utilized to increase the pressure in the departure tubes 110, either alone or in combination with smaller diameter departure tubes 110. Additionally, the angle of the plurality of departure tubes 110 may change depending on the dimensions of the reverse osmosis centrifuge 100.

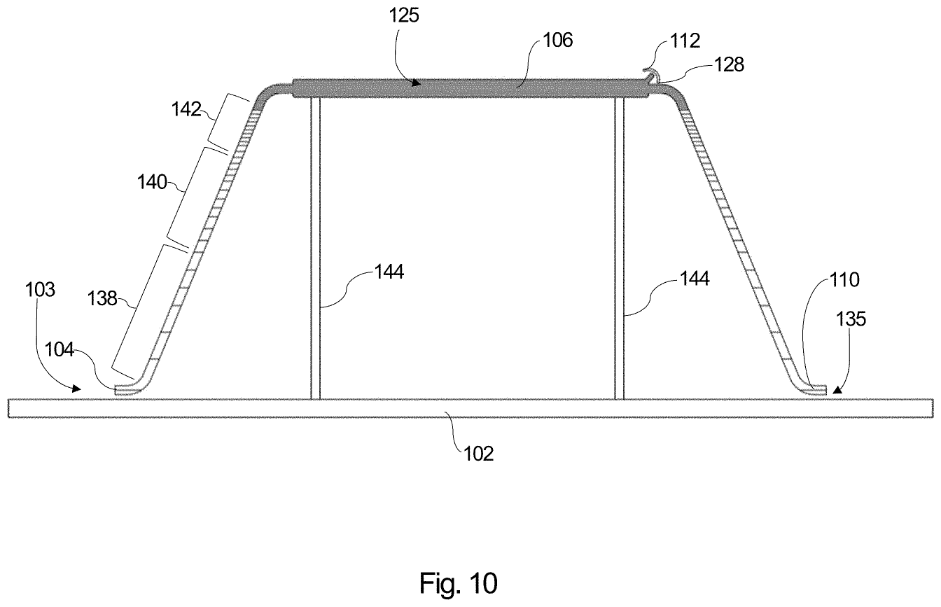

As shown in FIG. 10, the path of the feed flow resembles a “U” shape where the feed flow enters through the fluid inlet 122 at the first position 103. The flow path then gradually travels away from the first position 103, located on the vertical axis, to create more fluid pressure, where it reaches its max pressure at the plurality of housings 106 at the second position 125. The concentrate then gradually returns to center where it exits the plurality of departure tubes 110 at the second trough 116 at the third position 135 which is also located on the vertical axis. The objective of this geometry of the reverse osmosis centrifuge 100 is to maintain energy conservation in the feed flow. As the feed flow travels outward from the center, the centrifuge 100 adds energy to the fluid, which is manifested in a fluid velocity or centrifugal force. As the feed flow travels back towards the center, energy in the fluid is recovered through decreased velocity/centrifugal force, which aids in maintaining the rotation of the centrifuge 100. The necessary energy to drive the reverse osmosis centrifuge 100 is the difference between the quantities of feed flow traveling out versus in relative to the center of the reverse osmosis centrifuge 100. More specifically, when saltwater enters the plurality of receiving tubes 104, the saltwater is at a first, low pressure 138. As the saltwater travels down the plurality of receiving tubes 104, the pressure increases to a second, medium pressure 140 due to the rotational force. Lastly, after saltwater enters the plurality of housings 106, the saltwater is at a third, high pressure 142 (which occurs at second position 125) where it meets the filter 108 and is separated into two flow paths, permeate and concentrate. It will be appreciated that there is no mechanical wear or interfering surfaces in the high pressure region (second position 125) of the fluid, which may prevent wear on the reverse osmosis centrifuge 100. When the concentrate leaves the filter 108 and housing 106, it leaves in a reversed manner from how the saltwater entered. That is, from high pressure to low pressure as it is released via the plurality of departure tubes 110 at the third position 135. It should be noted that FIG. 10 illustrates an increase in pressure by the lines gradually becoming closer together as it moves away from the support shaft 102. In addition, referring to FIG. 10, the reverse osmosis centrifuge 100 may comprise support structures 144. The support structures 144 may be an aluminum, steel, or composite bracing. In some embodiments, the support structures 144 may be disks placed around the support shaft 102 and coupled to the plurality of housings 106. The support structures 144 may maintain the integrity of the apparatus when rotating so that the apparatus does not collapse or become otherwise damaged.

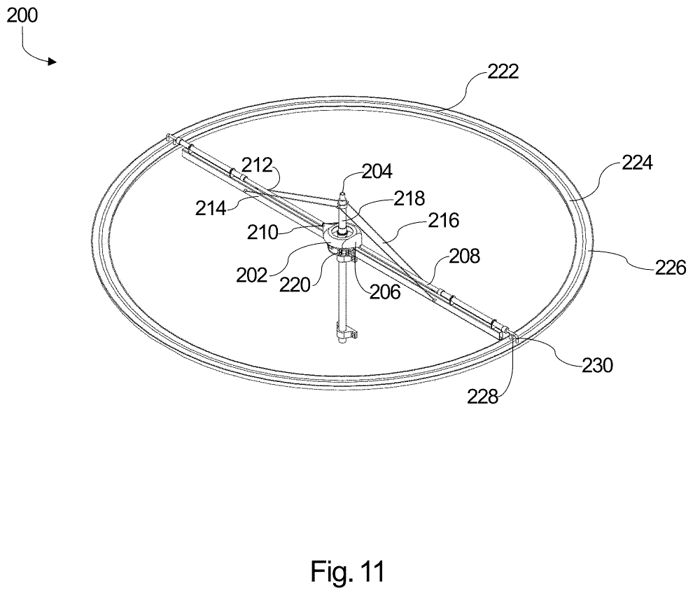

The reverse osmosis centrifuge 100 requires no energy recovery device because the process of recovering energy from the concentrate is an inherent function of the reverse osmosis centrifuge 100 because the concentrate returns to the axis. To show this effect, an equation that returns the torque necessary to rotate the device at a given diameter, RPM/pressure, and flow rate is shown. The formula is W=Q [Pgauge+(½)p(Q\hat{ }2/A\hat{ }2) (½)p(w\hat{ }2)(r\hat{ }2). This equation is a simplified application of the first Law of Thermodynamics. For example, at a 36″ radius, 1097 rpm, 800 psi, and 6 gpm of flow, ˜4.15 kw is required for continuous rotation. At an 18″ radius, 3470 rpm, 2000 psi, and 20 gpm of flow, ˜33 kw is required for continuous rotation. The examples above illustrate the torque necessary assuming no energy recovery is used with the system, which means that the concentrate and permeate are being ejected at the circumference of the reverse osmosis centrifuge 100, similar to what is shown in FIG. 11 and discussed later herein.

However, by moving the concentrate back to the center of the reverse osmosis centrifuge 100 by utilizing departure tubes 110, pressure/velocity is converted back into rotational energy. To illustrate this effect, a simple modification can be made to the flow rate equation. As an example, and to show the effect of the concentrate moving toward the center, at a 36″ radius, there is 800 psi, 6 gpm of concentrate flow toward the filter, 0.25 gpm of permeate production, and 5.75 concentrate flow leaving the filter traveling back toward the radius. As long as the flow is moving outward, the flowrate is a positive number; if the flow is moving in the opposite direction, the flowrate is a negative number. For continuous rotation, ˜4.15 kw is required for 6 gpm flow, and ˜−3.97 kw is required for 5.75 gpm return flow. 4.15 kw −3.97 kw=−0.18 kw (permeate energy consumption).

It should be noted that the difference between these two values is the energy required to produce the permeate. As shown and described above, the reverse osmosis centrifuge 100 only exhausts energy into the permeate production and none into the concentrate, which is a significant improvement over the prior art. In contrast, the prior art RO Trains exhaust energy into the permeate production and the concentrate, thus necessitating the use of an energy recovery device.

Further, the fluid pressure gradient is an inherent effect of the reverse osmosis centrifuge 100. At a given RPM, as fluid moves outward from the radius (i.e., axis), the fluid pressure increases. Pressure in the reverse osmosis centrifuge 100 is a function of the Specific Gravity of the solution, RPM, and the distance from the center of the axis. The following equation illustrates this relationship and the units are in Pa and Meters. The equation is PSI=5.4831 (r\hat{ }2)(RPM\hat{ }2). As an example of how this equation is applied, at a 24″/0.6096 m radius, an RPM of 2708 is required to create 800 psi/5.5 MPA of fluid pressure. At a 96″/2.4384 m radius, an RPM of 411 is required to create 800 psi/5.5 MPA of fluid pressure. In the examples above, as the radius increases, the RPM necessary to create a given fluid pressure decreases, and as the radius decreases, the RPM must then increase. Those familiar with fluid dynamics will appreciate that there will be some variance in the formulas above due to temperature, viscosity, and other variables, but the above formulations illustrate the technology and may be adaptable to conditions by those in the art.

Therefore, in one method of use, saltwater enters the reverse osmosis centrifuge 100 at first position 103 located at the center, vertical axis (i.e., shaft 102). As the reverse osmosis centrifuge 100 rotates on the support shaft 102 (i.e., shaft 102 spins/rotates on its longitudinal axis), saltwater is forced radially outward through the plurality of receiving tubes 104. As the saltwater travels outwardly from the center, the water pressure increases and reaches its max pressure at the housings 106, located at a second position 125, containing the filter 108. The permeate then exits into the trough 112 and the concentrate returns to the center axis, at a third position 135, via departure tubes 110. Because the concentrate returns to center, its pressure is recovered prior to leaving the system. It will be appreciated that while receiving tubes 104 and departure tubes 110 are used as examples, other components (e.g., trays) and methods of moving water from a first, centered position, to a second, radially distant, position for filtering, and then returning concentrate to a third, centered position, may be used and do not depart herefrom.

In one embodiment, as shown in FIG. 11, a reverse osmosis centrifuge 200 comprises a substantially oblate spheroid housing 202 and water inlet 204. The housing 202 comprises a first funnel 206 coupled to a first outlet arm 208 and a second funnel 210 coupled to a second outlet arm 212. As a result, as the housing 202 spins, water is forced radially outward, where it is funneled through first funnel 206 and second funnel 210 to outlet arms 208, 212, respectively. As shown, the housing 202 and outlet arms 208, 212 may be supported by framework 214. Framework 214 may be supported using cables 216 that are coupled to center support 218. As appreciated, the support framework 214 spins with the housing 202. Again, water easily flows to the plurality of water outlets arms 208, 212 and pressure builds at the end of each arm due to rotational forces and the length of the arms 208, 212. Accordingly, the rotationally-induced pressure (which may be referred to as “centrifugal” force) provides for desalination at a lower energy cost since the rotational pressure is more easily sustained than traditional pump pressures. This is due to the use of bearings to aid in the rotation of the housing 202 and framework 214. In other words, the housing 202 and framework coupler 220 are able to rotate (i.e., spin) on the center support 218 through the use of bearings. Once the reverse osmosis centrifuge is spinning, it takes less energy to maintain the spinning than a traditional pump uses, particularly if high-quality, low friction bearings are used. As a result, pressure at the ends of arms 208, 212 is maintained with less energy input. Additionally, there is no mechanical wear or interfering surfaces in the high pressure region of the fluid. As water travels through each outlet arm 208, 212, pressure increases. Accordingly, a desalination membrane or filter is positioned toward the distal end of each outlet 208, 212 arm where pressure is the highest. The reverse osmosis centrifuge 200 may further comprise a trough 222 having a concentrate trough 224 and a permeate trough 226 for receiving the output from a concentrate outlet 228 and a freshwater outlet 230. As a result, the reverse osmosis centrifuge desalinates water at a reduced energy cost, which translates into a reduced monetary cost, making the desalinating technology more readily available. It should be noted that, as mentioned earlier, the reverse osmosis centrifuge 200 does not return the concentrate to center, and is therefore not as efficient as other embodiments described herein.

In one embodiment, a reverse osmosis centrifuge comprises a rotatable housing, having an oblate spheroid form factor, having a water inlet and a plurality of water outlet arms. The rotatable housing is motor controlled so as to be easily rotatable (i.e., spinnable). As the rotatable housing spins, water in the rotatable housing is forced outward into the plurality of outlet arms. Each outlet arm extends radially from the rotatable housing. As water travels through each outlet arm, pressure increases. Accordingly, a desalination membrane or filter is positioned toward the distal end of each outlet arm where pressure is the highest. As a result, of the pressurized separation, concentrate exits a concentrate outlet and permeate exits the permeate outlets. The reverse osmosis centrifuge further comprises a trough for receiving the output from the concentrate outlets and permeate outlets, the trough divided into a concentrate trough and permeate trough so as to ensure separation of the permeate from the concentrate. The concentrate trough having a concentrate outlet and the permeate trough having a permeate outlet. In one embodiment, the concentrate trough is located near the axis of rotation.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A reverse osmosis centrifuge comprising:
a support shaft;
a plurality of receiving tubes, coupled to the support shaft at a first position, to receive water;
a plurality of housings, each housing coupled to a distal end of each receiving tube in a second position, for receiving and filtering saltwater, the plurality of housings comprising:
filters positioned inside of each of the plurality of housings to separate saltwater into concentrate and permeate,
a permeate outlet, and
a departure aperture for the outlet of the concentrate;
a plurality of departure tubes, each coupled to the departure aperture of a respective housing; and
a permeate trough to receive the permeate from each permeate outlet.

2. The reverse osmosis centrifuge of claim 1, further comprising a first trough for receiving water from a fluid inlet.

3. The reverse osmosis centrifuge of claim 2, wherein the first trough comprises a plurality of first apertures and a first support shaft aperture.

4. The reverse osmosis centrifuge of claim 3, wherein the first support shaft aperture receives the support shaft in a first position.

5. The reverse osmosis centrifuge of claim 1, wherein the plurality of housings are vertically positioned to allow gravity to induce feed flow.

6. The reverse osmosis centrifuge of claim 1, wherein the plurality of housings are fiberglass.

7. The reverse osmosis centrifuge of claim 1, wherein the filter is a graphene membrane.

8. The reverse osmosis centrifuge of claim 1, wherein the filter is a cellulose triacetate membrane.

9. The reverse osmosis centrifuge of claim 1, wherein the plurality of departure apertures are positioned on a bottom of the plurality of housings.

10. The reverse osmosis centrifuge of claim 1, further comprising a second trough for releasing the concentrate.

11. The reverse osmosis centrifuge of claim 10, wherein the second trough comprises a plurality of second apertures and a second support shaft aperture for receiving the support shaft.

12. The reverse osmosis centrifuge of claim 11, wherein the second support shaft aperture receives the support shaft at a third position.

13. A reverse osmosis centrifuge comprising:
a fluid inlet;
a first trough comprising a plurality of first apertures and a first support shaft aperture, the first support shaft aperture receiving a support shaft at a first position;
a plurality of receiving tubes coupled to the plurality of first apertures for receiving water at the first position, each receiving tube extending radially from the support shaft;
a plurality of housings, located at a second position distal to the support shaft, for receiving and filtering water, the plurality of housings each comprising:
receiving apertures for coupling to the plurality of receiving tubes,
a filter positioned inside of the plurality of housings to separate saltwater into concentrate and permeate,
a permeate outlet, and
a departure aperture for the outlet of the concentrate;
a second trough, at a third position, comprising a plurality of second apertures and a second support shaft aperture, the second support shaft aperture receiving the support shaft;
a plurality of departure tubes, each coupled to the departure aperture of a respective housing, to release the concentrate from the plurality of housings; and
a permeate trough to receive the permeate from the permeate outlet;
wherein when the saltwater enters the plurality of receiving tubes, it is at a low pressure, and when the saltwater is in the plurality of receiving tubes it is at a medium pressure, and when the saltwater is in the plurality of housings it is at high pressure.

14. The reverse osmosis centrifuge of claim 13, wherein the plurality of housings are vertically positioned to allow gravity to induce feed flow.

15. The reverse osmosis centrifuge of claim 13, wherein the plurality of housings are fiberglass.

16. The reverse osmosis centrifuge of claim 13, wherein the plurality of departure apertures are positioned on a bottom of the plurality of housings.

17. A method of using a reverse osmosis centrifuge to perform reverse osmosis, the method comprising:
inputting water into the reverse osmosis centrifuge at a first, center position;
rotating the reverse osmosis centrifuge to cause the water to spin radially outward to a second, distal position;
filtering the water at the second position, where pressure is the highest;
outputting the resulting permeate;
causing the remaining concentrate to return to a third, center position to recover the energy from the concentrate.

18. The method of claim 17, wherein the first, center position is in a highest position, the second, distal position is in a lower position than the first position, and the third, center position is lower than both the first and second positions, allowing gravity to be a contributing energy force.
